(19) United States
(12) Patent Application Publication
(10) Pub. No.: US 2021/0068336 A1
(43) Pub. Date: Mar. 11, 2021

(54) METHOD FOR REDUCTION OF SALT STRESS SYMPTOMS DURING PLANT CULTIVATION IN SALINE CONDITIONS BY APPLICATION OF CARBON-BASED NANOMATERIALS (CBN) TO GROWTH MEDIUM AND APPLICATIONS OF SAME

(71) Applicant: BOARD OF TRUSTEES OF THE UNIVERSITY OF ARKANSAS, Little Rock, AR (US)

(72) Inventors: Mariya Khodakovskaya, Little Rock, AR (US); Mohamed Hassen Lahiani, North Little Rock, AR (US)

(21) Appl. No.: 17/015,227

(22) Filed: Sep. 9, 2020

Related U.S. Application Data
(60) Provisional application No. 62/897,916, filed on Sep. 9, 2019.

(51) Int. Cl. A01C 1/00; C01B 32/158; C01B 32/182; A01G 24/12

(52) U.S. Cl. CPC A01C 1/00; C01B 32/158; B82Y 30/00; A01G 24/12; C01B 32/182

(57) ABSTRACT

A method for reducing salinity stress symptoms in a seed plant, comprising the step of adding carbon-based nanomaterials into a salinity growth medium in which the seed plant is cultivated, the salinity growth medium is in a salinity condition which causes the seed plant cultivated in the growth medium demonstrates the salinity stress symptom.

### CROSS-REFERENCE TO RELATED PATENT APPLICATION

This application claims priority to and the benefit of, pursuant to 35 U.S.C. § 119(e), U.S. Provisional Patent Application Ser. No. 62/897,916, filed Sep. 9, 2019, which is incorporated herein in its entirety by reference.

### FIELD OF THE INVENTION

The invention relates to a methodology, a formula or a system for reducing salt stress and/or water deficit stress symptoms of seed plants, particularly, by application of carbon-based nanomaterials (CBN) to growth medium for the seed plants.

### BACKGROUND OF THE INVENTION

The background description provided herein is for the purpose of generally presenting the context of the present invention. The subject matter discussed in the background of the invention section should not be assumed to be prior art merely as a result of its mention in the background of the invention section. Similarly, a problem mentioned in the background of the invention section or associated with the subject matter of the background of the invention section should not be assumed to have been previously recognized in the prior art. The subject matter in the background of the invention section merely represents different approaches, which in and of themselves may also be inventions.

Soil salinity is one of the most important global problems that negatively affects crop productivity. Salt toxicity, salt stress, and water deficit can cause a number of symptoms to seed plants and therefore significantly impact the growth of seed plants, including germination rate, development of shoot and root of the plants, leaves volume, flowers and fruits productions. Salinity impairs plant growth and development via water stress, cytotoxicity due to excessive uptake of ions such as sodium (Na⁺) and chloride (Cl⁻), and nutritional imbalance.

The earliest response of plants to salt stress is reduction in the rate of leaf surface expansion followed by cessation of expansion as the stress intensifies but growth resumes when the stress is relieved. Metabolic processes like photosynthesis, protein synthesis and lipid metabolisms are affected due to salt stress. Salinity is responsible for different types of stresses like, osmotic stress, ionic stress, oxidative stress and hormonal imbalances. The osmotic stress is caused by the excess of Na⁺ and Cl⁻ ions in the soil that decrease the osmotic potential and hampers the water uptake and nutrients. Low molecular mass compounds known as compatible solutes is accumulated under salt stress. These compatible solutes include proline, glycinebetaine, sugars, proteins, polyols, etc.

Salinity is a major stress limiting the increase in the demand for food crops. More than 20% of cultivated land worldwide (˜about 45 hectares) is affected by salt stress and the amount is increasing day by day. For all important crops, average yields are only a fraction˜somewhere between 20% and 50% of record yields; these losses are mostly due to drought and high soil salinity, environmental conditions which will worsen in many regions because of global climate change. A wide range of adaptations and mitigation strategies are required to cope with such impacts. Efficient resource management and crop/livestock improvement for evolving better breeds can help to overcome salinity stress. However, such strategies being long drawn and cost intensive.

Therefore, there is an imperative need for reducing the salt stress/water deficit symptoms of seed plant, so as to improve the agricultural production.

### SUMMARY OF THE INVENTION

One of the objectives of the invention is to provide a method for reversing and/or relieving the salinity stress symptoms in a seed plant.

In one embodiment, the present invention relates to a method for reducing salinity stress symptoms in a seed plant, the method comprises a step of adding carbon-based nanomaterials into a salinity growth medium in which the seed plant is cultivated,

In one embodiment, the salinity growth medium is in a salinity condition which causes the seed plant cultivated in the growth medium demonstrates the salinity stress symptom.

In one embodiment, the carbon-based nanomaterials comprises at least one of carbon nanotubes (CNT) and graphene.

In one embodiment, the salinity stress symptom is at least one of lower germination rate, shorter shoot length, and shorter root length, as compared to the seed plant cultivated in a non-salinity growth medium.

In one embodiment, the salinity stress symptom is at least one of less leaf production, less flower production, and less fruit production, as compared to the seed plant cultivated in a non-salinity growth medium.

In one embodiment, the concentration of CNT ranges between 50-1000 μg/ml; the concentration of graphene ranges between 50-1000 μg/ml.

In one embodiment, the seed plant is one of switchgrass, sorghum, cotton, and Catharanthus roseus.

In one embodiment, the salinity growth medium is in a liquid phase or a solid phase. The liquid phase is agar or hydroponics. The solid phase is soil or soil mix.

In one embodiment, the carbon-based nanomaterials increase the expression of genes encoding aquaporins, particularly, PIP1;5.

In another embodiment, the invention relates to a method for relieving drought symptoms demonstrated by a seed plant cultivated in a growth medium, the method comprises a step of adding carbon-based nanomaterials into the growth medium in which the seed plant is cultivated for a treatment period before a water deprivation period.

In one embodiment, carbon-based nanomaterials comprises at least one of carbon nanotubes (CNT) and graphene.

In one embodiment, the concentration of CNT ranges between 20-800 mg per 400 g growth medium; the concentration of graphene ranges between 20-800 mg per 400 g growth medium.

In one embodiment, the seed plant is one of cotton and Catharanthus roseus.

In one embodiment, after the water deprivation period, leaf relative water content of the seed plant cultivated in the growth medium supplemented by the carbon-based nanomaterials is higher than the leaf relative water content of the seed plant cultivated in a growth medium not supplemented by the carbon-based nanomaterials.

In one embodiment, the treatment period is at least two weeks.

In another embodiment, the present invention relates to a method for increasing the yield production of a seed plant, the method comprises a step of adding carbon-based nanomaterials into a growth medium in which the seed plant is cultivated.

In one embodiment, the carbon-based nanomaterials comprises at least one of carbon nanotubes (CNT) and graphene.

In one embodiment, the concentration of CNT ranges between 50-1000 μg/ml; the concentration of graphene ranges between 50-1000 μg/ml.

In one embodiment, the seed plant is cotton.

In one embodiment, the yield production is fiber weight produced by the cotton; the fiber weight produced by the cotton cultivated in the growth medium supplemented by the carbon-based nanomaterials is more than the fiber weight produced by the cotton cultivated in the growth medium that is not supplemented by the carbon-based nanomaterials.

These and other aspects of the present invention will become apparent from the following description of the preferred embodiments, taken in conjunction with the following drawings, although variations and modifications therein may be affected without departing from the spirit and scope of the novel concepts of the disclosure.

### BRIEF DESCRIPTION OF THE DRAWINGS

The accompanying drawings illustrate one or more embodiments of the invention and, together with the written description, serve to explain the principles of the invention. The same reference numbers may be used throughout the drawings to refer to the same or like elements in the embodiments.

FIG. 1 shows the addition of graphene (A) and multi-walled CNTs (B) can reduce the negative effect of NaCl on germination of switchgrass seeds.

FIG. 2 shows the addition of CNTs (A, B) and graphene (C, D) to growth medium reduce suppression of shoot and root length of 10-days old sorghum seedlings exposed to 100 mM NaCl.

FIG. 3 shows real-time PCR analysis of expression of sorghum water channel gene (PIP 1;5) in 10 day-old sorghum shoots (A, C) and roots (B, D) grown in saline Murashige and Skoog medium (100 mM NaCl) supplemented with a wide range of CNTs concentrations (A, B) or graphene (C, D).

FIG. 4 shows measurements of electrode potential of saline solutions supplemented with CNTs using sodium ion selective electrode.

FIG. 5 shows cctivation of seed germination by application of CBNs in cotton and Catharanthus under salt stress.

FIG. 6 shows growth and developments of seedlings of cotton and Cathatanthus exposed to CBNs under salt stress in vitro.

FIG. 7 shows long-term application of CBNs to salty soil reduced the toxic effects of salt stress and improved the growth and yield of Catharanthus.

FIG. 8 shows long-term application of CBNs to salty soil reduced the toxic effects of salt and improved the growth and yield of cotton.

FIG. 9 shows the phenotype of Catharanthus plants grown in conditions of water deficit stress in presence of CBNs.

FIG. 10 shows effects of CBNs on leaf relative water content of Catharanthus cultivated at CNTs mixed soil (A) and graphene mixed soil (B) in conditions of more ware deficit stress.

### DETAILED DESCRIPTION OF THE INVENTION

The invention will now be described more fully hereinafter with reference to the accompanying drawings, in which exemplary embodiments of the invention are shown. This invention may, however, be embodied in many different forms and should not be construed as limited to the embodiments set forth herein. Rather, these embodiments are provided so that this invention will be thorough and complete, and will fully convey the scope of the invention to those skilled in the art. Like reference numerals refer to like elements throughout.

The terms used in this specification generally have their ordinary meanings in the art, within the context of the invention, and in the specific context where each term is used. Certain terms that are used to describe the invention are discussed below, or elsewhere in the specification, to provide additional guidance to the practitioner regarding the description of the invention. For convenience, certain terms may be highlighted, for example using italics and/or quotation marks. The use of highlighting has no influence on the scope and meaning of a term; the scope and meaning of a term is the same, in the same context, whether or not it is highlighted. It will be appreciated that same thing can be said in more than one way. Consequently, alternative language and synonyms may be used for any one or more of the terms discussed herein, nor is any special significance to be placed upon whether or not a term is elaborated or discussed herein. Synonyms for certain terms are provided. A recital of one or more synonyms does not exclude the use of other synonyms. The use of examples anywhere in this specification including examples of any terms discussed herein is illustrative only, and in no way limits the scope and meaning of the invention or of any exemplified term. Likewise, the invention is not limited to various embodiments given in this specification.

It will be understood that, as used in the description herein and throughout the claims that follow, the meaning of “a”, “an”, and “the” includes plural reference unless the context clearly dictates otherwise. Also, it will be understood that when an element is referred to as being “on” another element, it can be directly on the other element or intervening elements may be present there between. In contrast, when an element is referred to as being “directly on” another element, there are no intervening elements present. As used herein, the term “and/or” includes any and all combinations of one or more of the associated listed items.

It will be understood that, although the terms first, second, third etc. may be used herein to describe various elements, components, regions, layers and/or sections, these elements, components, regions, layers and/or sections should not be limited by these terms. These terms are only used to distinguish one element, component, region, layer or section from another element, component, region, layer or section. Thus, a first element, component, region, layer or section discussed below could be termed a second element, component, region, layer or section without departing from the teachings of the invention.

Furthermore, relative terms, such as “lower” or “bottom” and “upper” or “top,” may be used herein to describe one element's relationship to another element as illustrated in the figures.

It will be understood that relative terms are intended to encompass different orientations of the device in addition to the orientation depicted in the figures. For example, if the device in one of the figures is turned over, elements described as being on the “lower” side of other elements would then be oriented on “upper” sides of the other elements. The exemplary term “lower”, can therefore, encompasses both an orientation of “lower” and “upper,” depending of the particular orientation of the figure. Similarly, if the device in one of the figures is turned over, elements described as “below” or “beneath” other elements would then be oriented “above” the other elements. The exemplary terms “below” or “beneath” can, therefore, encompass both an orientation of above and below.

It will be further understood that the terms “comprises” and/or “comprising,” or “includes” and/or “including” or “has” and/or “having”, or “carry” and/or “carrying,” or “contain” and/or “containing,” or “involve” and/or “involving, and the like are to be open-ended, i.e., to mean including but not limited to. When used in this invention, they specify the presence of stated features, regions, integers, steps, operations, elements, and/or components, but do not preclude the presence or addition of one or more other features, regions, integers, steps, operations, elements, components, and/or groups thereof.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and the present invention, and will not be interpreted in an idealized or overly formal sense unless expressly so defined herein.

As used herein, the phrase at least one of A, B, and C should be construed to mean a logical (A or B or C), using a non-exclusive logical OR. As used herein, the term “and/or” includes any and all combinations of one or more of the associated listed items.

Even though the embodiments of the prevent invention include sorghum, switchgrass, cotton, Catharanthus roseus, the present invention is also applicable to other living plants, especially, seed plants.

The description below is merely illustrative in nature and is in no way intended to limit the invention, its application, or uses. The broad teachings of the invention can be implemented in a variety of forms. Therefore, while this invention includes particular examples, the true scope of the invention should not be so limited since other modifications will become apparent upon a study of the drawings, the specification, and the following claims. For purposes of clarity, the same reference numbers will be used in the drawings to identify similar elements. It should be understood that one or more steps within a method may be executed in different order (or concurrently) without altering the principles of the invention.

The present invention has concluded that the introduction of carbon-based materials (CBN), such as multi-walled carbon nanotubes (CNTs) or graphene, into a growth medium containing a high concentration of salt can dramatically reduce the inhibition of switchgrass seed germination caused by toxicity of NaCl. In particular, the addition of graphene (A) and multi-walled CNTs (B) into the growth medium can reduce the negative effect of NaCl on germination of switchgrass seeds cultured in the growth medium.

With respect to the following experiments, unless specifically indicated otherwise, for positive control, seeds were placed on regular Murashige and Skoog medium (MS). For negative control, seeds were placed on MS medium supplemented with 100 mM NaCl. For treatment with CNTs and graphene, seeds were placed on MS medium supplemented with 100 mM NaCl and different concentrations of CNTs or graphene (50, 100, 200, 500, 1000 μg/ml), respectively.

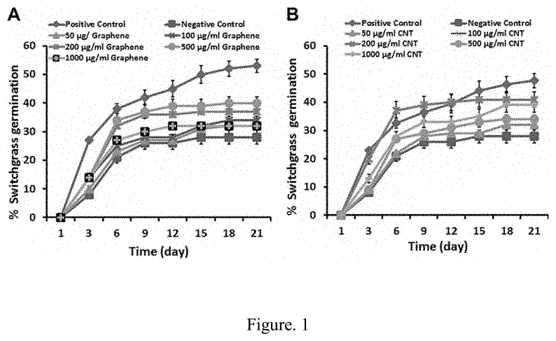

FIG. 1 shows that the positive control whose MS medium is free of NaCl has the highest germination rate, while the negative control whose MS medium contains 100 mM NaCl without any CNTs or graphene as supplement has the lowest germination rate. More importantly, between the positive control and negative control, the switchgrass seeds, which was cultured on the growth mediums that are treated with 500 μg/ml of graphene and 200 μg/ml of CNTs, respectively, has the highest germination rate.

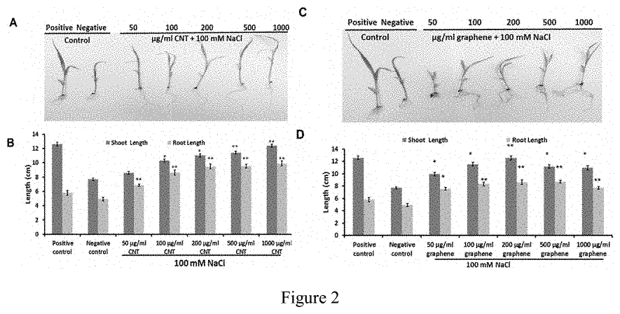

FIG. 2 shows that the addition of CNTs and graphene to growth medium significantly reduced the suppression of shoot and root length of switchgrass seedlings exposed to 100 mM NaCl for 21 days.

As shown in FIG. 2, the addition of CNTs (A, B) and graphene (C, D) to growth medium reduce suppression of shoot and root length of 10-days old sorghum seedlings exposed to 100 mM NaCl. For positive control (P) seedlings were grown on regular MS medium. For negative control (N) seedlings were grown on MS medium supplemented with 100 mM NaCl. For treatment with CBNs, seedlings were grown on MS medium supplemented with 100 mM NaCl and different concentrations of CNTs or graphene (50, 100, 200, 500, 1000 μg/ml). (*=p<0.05 and **=p<0.01).

It should be noted that the shoot and root length of sorghum were dramatically reduced when NaCl (100 mM) was added to MS medium (negative control). However, this reduction was reversed when graphene or CNTs in concentrations between 100-1000 μg/ml were added to medium supplemented with sodium chloride. To illustrate how application of the CNTs and graphene relief and/or reserve the symptoms that seed plants demonstrate when the seed plants are cultivated in saline conditions with high concentration of salt, expression of water channel genes (aquaporins) in young seedlings of sorghum are determined.

Water channel genes encode aquaporins which are channel proteins from a larger family of major intrinsic proteins that form pores in the membrane of biological cells, mainly facilitating transport of water between cells. The cell membranes of a variety of different bacteria, fungi, animal and plant cells contain aquaporins through which water can flow more rapidly into and out of the cell than by diffusing through the phospholipid bilayer.

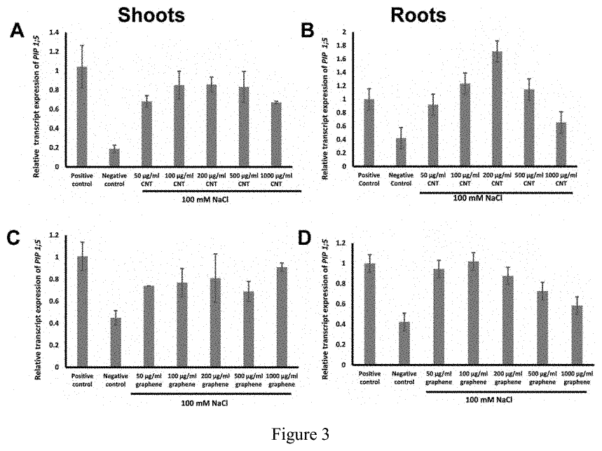

As reflected in FIG. 3, the present invention shows that the CNTs activate expression of water channel genes in young seedlings of sorghum. Two common sorghum aquaporin (PIP 1;5) were selected for real-time PCR analysis. Young seedlings of sorghum were cultured in MS medium in the positive control and were exposed to NaCl (100 mM) in MS medium in the negative group. In other test groups, young seedlings of sorghum are exposed to NaCl (100 mM) with and without exposure to graphene and CNTs having a concentration between 50-1000 μg/ml.

FIG. 3 shows the Real-time PCR analysis of expression of sorghum water channel gene (PIP 1;5) in 10 day-old sorghum shoots (A, C) and roots (B, D) grown in saline MS medium (100 mM NaCl) supplemented with a wide range of CNTs concentrations (A, B) or graphene (C, D). For positive control, seedlings were grown on regular MS medium. For negative control, seedlings were grown on MS medium supplemented with 100 mM NaCl.

As shown in FIG. 3, expression of the PIP 1;5 gene was reduced in shoots and roots of sorghum when NaCl was added to growth medium but was dramatically enhanced when the salty medium was also supplemented with graphene (FIG. 3B, D) or CNTs (FIG. 3A, C). Concentrations of 100-200 μg/ml for CNTs and 50-200 μg/ml for graphene were the most efficient for activation of PIP 1;5 gene expression.

To shed more light on the mechanism of reduction of toxic symptoms in sorghum exposed to salt stress, the present invention contains an experiment related to the evaluation of Na⁺ and Cl-ion amounts in salty solutions supplemented with CNTs. Sodium selective electrode and chloride selective electrode were used for the tests. It is well known that electrode potential directly correlates with the concentration of a specific ion in solutions investigated using an ion selective electrode.

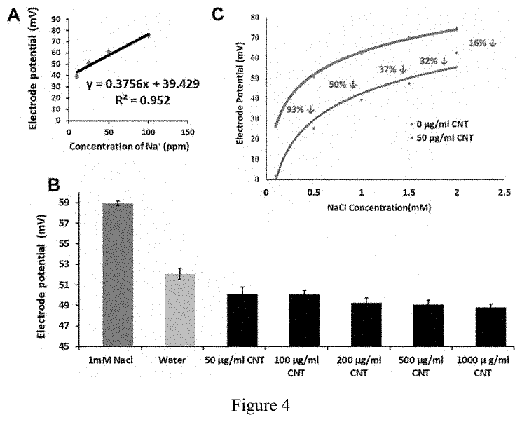

First, using standard solutions, a standard curve as electrode potential (mV) versus concentration of salt ions (ppm) for each used electrode (FIG. 4A) is constructed. Then, the electrode potential of water and solutions with a range of NaCl concentrations (0; 0.5; 1; 1.5; 2; 2.5 mM) supplemented with 50 μg/ml of CNTs were measured using sodium ion selective electrode (FIG. 4C). Finally, the electrode potential of 1 mM NaCl solution and the same solution after adding the same volume of water and the same volume of CNTs in the range of concentrations (50; 100; 200; 500; 1000 μg/ml) were measured as well (FIG. 4B).

FIG. 4C shows that the addition of water to 1 mM NaCl (dilution) resulted in an expected decrease in electrode potential (FIG. 4C). However, when the same volume of CNT solution was added to 1 mM NaCl solution, the electrode potential of saline solution was further decreased. After data analysis, we have concluded that CNTs most likely can interact with sodium ions and probably absorb such Na+ ions.

In other embodiments of the invention, the effects of CBN to reduce/relief the salt stress and water deficit symptoms are tested on other species of seed plants, including Catharanthus and cotton.

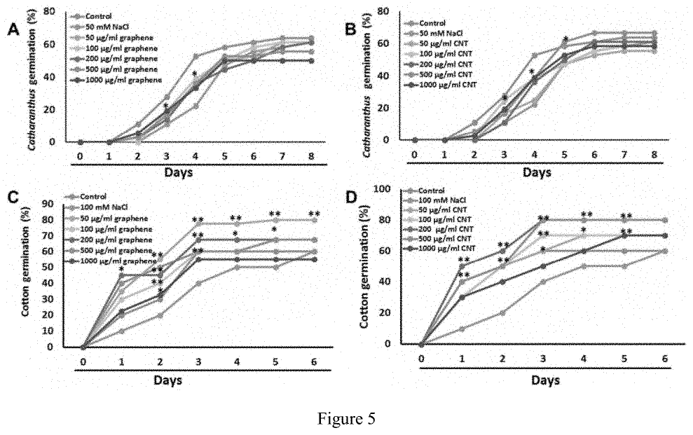

Salt, such like NaCl, is toxic for both Catharanthus and cotton species and reduce rate of germination of Catharanthus and cotton. FIG. 5 shows that the activation of seed germination by application of CBNs in growth medium for cotton and Catharanthus under salt stress. Effects of graphene (A, C) and multi-walled CNTs (B, D) on seed germination of Catharanthus (A, B) and cotton (C, D) exposed to salty growth media are demonstrated. 50 mM NaCl and 100 mM NaCl was used to impose salt stress in Catharanthus and cotton, respectively. The statistical significance was determined as compared to seeds exposed to only NaCl by p<0.05 and p<0.01 (*=p<0.05 and **=p<0.01).

As it can be determined from the FIG. 5, the application of CBNs to salty growth medium reverses the toxic effects of the salts, and, indeed, enhances the seed germination of both tested crops positively. The CBNs concentrations between a range of 50 μg/ml to 200 μg/ml are the most effective for reversal of inhibition of Catharanthus seed germination caused by the salt stress. Both CNTs and graphene significantly activate the cotton germination as well. For example, the application of 50 and 100 μg/ml CNTs to NaCl exposed cotton seeds resulted in a 30% increase in germination as compared to treated cotton seeds treated with only NaCl at day-4. The addition of 50 μg/ml graphene to NaCl exposed seeds increases the cotton germination by 37.5% as compared to cotton seeds treated with only NaCl (FIG. 5C, D).

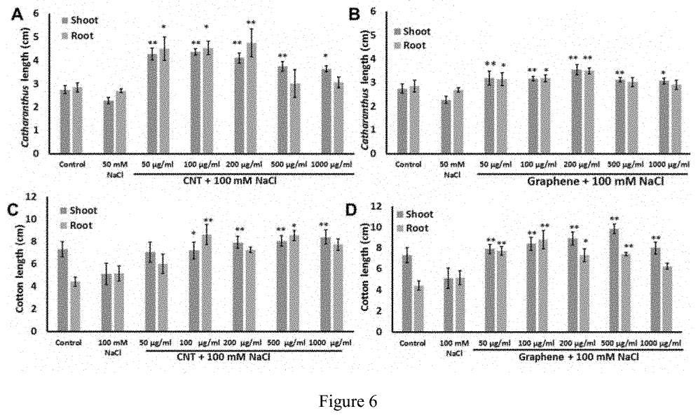

FIG. 6 shows the effects of CBNs on growth and yield of cotton and Catharanthus exposed to salt stress by measuring the length of the shoot and root of the cotton and Catharanthus. In particular, the present invention includes several tests to investigate the effect of two CBNs on tolerance of young and mature cotton and Catharanthus plants to salt stress.

Based on the observed intensity of toxicity of NaCl in tested species, we selected 50 mM NaCl for Catharanthus and 100 mM NaCl for cotton in further stress experiments. FIG. 6 shows the growth and developments of seedlings of cotton and Cathatanthus exposed to CBNs under salt stress in vitro. Effects of CNTs (A, C) and graphene (B, D) on the growth of 4-week-old Catharanthus (A, B) and 1-week-old cotton (C, D) exposed to agar MS medium supplemented with NaCl are reflected. (*=p<0.05 and **=p<0.01).

In particular, 4-week-old Catharanthus seedlings exposed to 50 mM NaCl reduces the root length by 5.28% and shoot length by 17.09% as compared to control (untreated) seedlings. However, the phenotypic analysis of young seedlings exposed to both CBNs and NaCl reveals that the introduction of both tested CBNs to salty growth medium dramatically reduced the toxic symptoms of NaCl and positively affects the seedling growth of both Catharanthus and cotton (FIG. 6A-D).

Importantly, it should be noted that exposure of young seedlings (cotton, Catharanthus) to salty growth media results in higher root and shoot length as compared to control seedlings (seedlings grown on regular growth media). In a detail, CBNs concentration between a range of 50-200 μg/ml results in better seedlings developments as compared to that of untreated seedlings in Catharanthus.

For example, the introduction of 100 μg/ml CNTs to the salty medium (50 mM NaCl) increases shoot length by 47% and root length by 40% as compared to Catharanthus seedlings exposed to NaCl only (FIG. 6A). Similarly, the application of 100 μg/ml graphene led to the increase in root length by 15.24% and shoot length by 28% as compared to Catharanthus seedlings exposed to NaCl only (FIG. 6B).

Working with cotton, it is found that addition of 100 mM NaCl to the agar growth medium reduces the shoot length by 30% of young cotton plants. Meanwhile, the applications of CBNs to salty agar medium results in the reversal of NaCl toxicity and improvement of seedlings development towards to normal (control) level. For example, the introduction of 1000 μg/ml CNTs to NaCl supplemented growth medium results in an increase of cotton shoot length by 64% as compared to seedlings exposed to medium supplemented with only NaCl. Similarly, the addition of 100 μg/ml CNTs results in an increase in root length by 66% as compared to cotton seedlings exposed to NaCl only (FIG. 6C).

Similar effects of graphene on the development of cotton seedlings under salt stress conditions are observed as well. For example, the application of 500 μg/ml graphene lead to increasing shoot length by 93% as compared to seedlings exposed to NaCl only. Similarly, the introduction of 100 μg/ml graphene shows an increase in root length (70%) as compared to seedlings exposed to NaCl only (FIG. 6D). The applications of CNTs and graphene improves the overall root and shoot biomass of Catharanthus seedlings grown under salt stress.

The greenhouse experiments reveals that cultivation of Catharanthus in salty soil led to a significant reduction in overall plant growth including delayed flower production and changed plant architecture as compared to Catharanthus cultivated in regular soil.

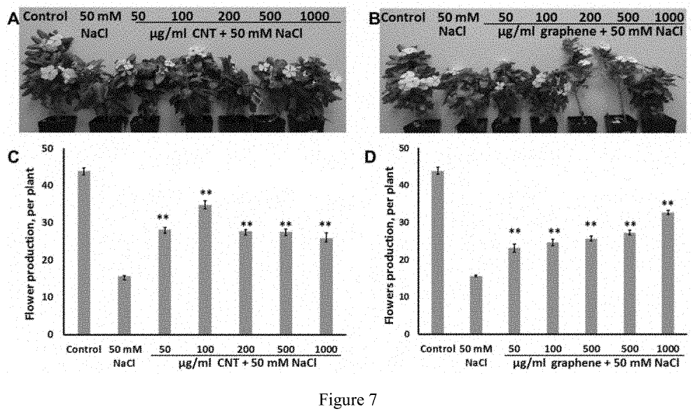

FIG. 7 shows that long-term application of CBNs to salty soil reduces the toxic effects of salt stress and improves the growth and yield of Catharanthus. The introduction of CBNs to salty soil positively affectes the production of flowers in Catharanthus cultivated in CNT-mixed soil (A, C) and graphene mixed-soil under imposes salt stress (B, D). Control Catharanthus are grown on regular soil, NaCl exposed Catharanthus are grown at soil supplemented with 50 mM NaCl and CBNs exposed Catharanthus are cultivated at soil supplemented with 50 mM NaCl in presence of different concentrations of CNTs or graphene. (*=p<0.05 and **=p<0.01).

As shown by FIG. 7, cultivation of Catharanthus in NaCl supplemented soil results in reduction of a total number of flower production by 64.38% as compared to untreated (control) Catharanthus. However, the addition of nanomaterials (CNTs or graphene) to salty soil reduces the toxic effects of NaCl and improves the several phenotypic traits including the early flower development along with total number of flowers yield as compared to Catharanthus plants exposed to NaCl mixed soil.

All tested concentration of CBNs are very effective for the reducing of the toxic symptoms caused by NaCl, and for enhancing the flower production in Catharanthus under NaCl mediated salt stress.

For instance, the introduction of 100 μg/ml CNTs to the salty soil (NaCl) leads to an increase of flower production by 55%, as compared to Catharanthus plants cultivated in soil supplemented only with NaCl. Similarly, the introduction of 1000 μg/ml graphene to the salty soil leads to enhancement of flower production by 52.10% as compared to Catharanthus plants cultivated in soil supplemented with only NaCl.

Additionally, the present invention also shows that the application of CBNs to salty soil significantly increases the total number of leaves produced by matured Catharanthus plants as compared to Catharanthus plant exposed to NaCl only.

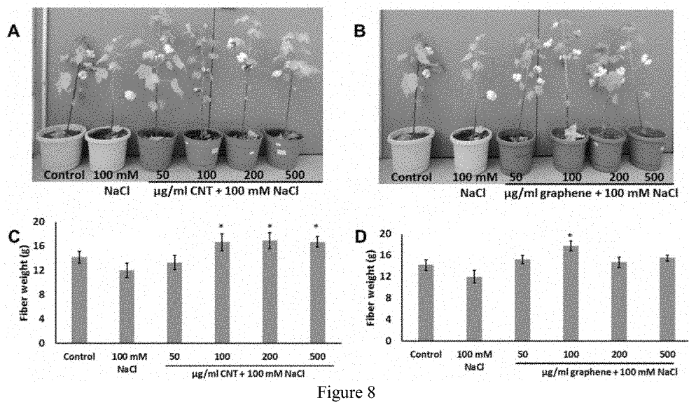

In particular, FIG. 8 shows that the long-term application of CBNs to salty soil reduces the toxic effects of salt and improved the growth and yield of cotton. The introduction of CBNs to salty soil enhances the fiber yield of cotton cultivated in CNT mixed soil (A, C) and graphene mixed soil under salt stress conditions (B, D). Control cotton plants were grown on regular soil, NaCl treated cotton was grown in soil supplemented with 100 mM NaCl and CBNs exposed cotton was grown in CNTs or graphene mixed salty soil (100 mM NaCl). (*=p<0.05 and **=p<0.01).

As reflected in the FIG. 8, the introduction of CNTs and graphene to Catharanthus plant cultivated salty soil leads to an increase in total leaf number of leaves by 48.1% and 47.86%, respectively, as compared to Catharanthus plants cultivated in soil supplemented with only NaCl.

Similar results are recorded for NaCl exposed cotton plants by introduction of nanomaterials through watering with CBN solution during 4 weeks. Long-term applications of CBNs reduces the toxic symptoms caused by NaCl and improved fiber yield under salt stress condition. For instance, the introduction of 100-500 μg/ml CNTs and 200 μg/ml graphene to salty soil significantly increases cotton fiber biomass yield as compared to cotton plants cultivated in only NaCl treated the soil. In details, matured cotton plants exposed to CNT and graphene increases the fiber biomass by 15.93% and 16.8%, respectively, as compared to cotton treated with NaCl only.

Except for the salt stress, water deficit is another significant problemn faced by the agriculture industry worldwide.

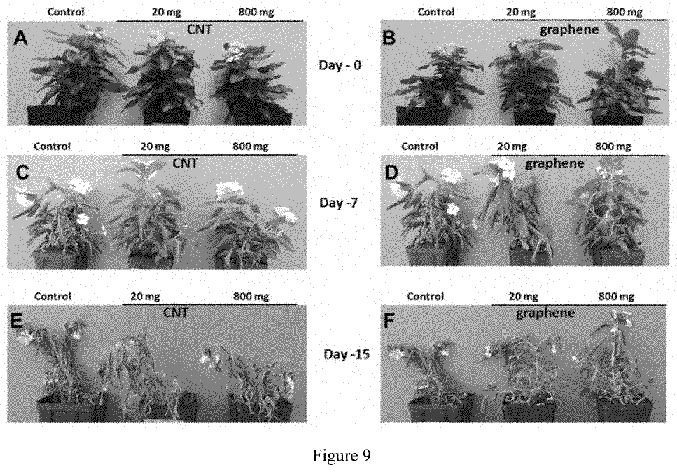

FIG. 9 shows the phenotype of Catharanthus plants grown in conditions of water deficit stress in presence of CBNs. Effects of CNT (A) and graphene (B) on the phenotype of Catharanthus at day 0 of stress (A, B) day-7 (C, D) and day-15 (E, F) of water deficit stress. The final concentration of nanomaterials (*=p<0.05 and **=p<0.01). Final concentration of CNT and graphene was 20 mg or 800 mg per 400 g of soil mix. Delivery of CNT to soil mix was achieved by the addition of CNT of graphene solution to the soil during 4 weeks.

In order to investigate the effects of CBNs on response to water deficit of ornamental species (Catharanthus), 10 week-old CNT-exposed and control (untreated) Catharanthus plants were deprived of water for 2 weeks. After one week of drought stress, untreated Catharanthus plants (control) showed expected signs of water deficit stress as indicated by leaf wilting, while very slight stress symptoms were observed for Catharanthus plants previously treated with graphene or CNTs (FIG. 9C, D). Treatment was performed as described above. After two weeks of drought stress, untreated Catharanthus plants were completely dried whereas, Catharanthus plants exposed to graphene show the symptoms of leaf wilting but plants were not completely dried (FIG. 9E, F). The observed phenotypic difference between control and CBNs treated Catharanthus linked to doses of applied CBNs and intensity of water deficit stress of plants.

Therefore, the applications of CBNs can enhance the stress tolerance of Catharanthus against drought stress.

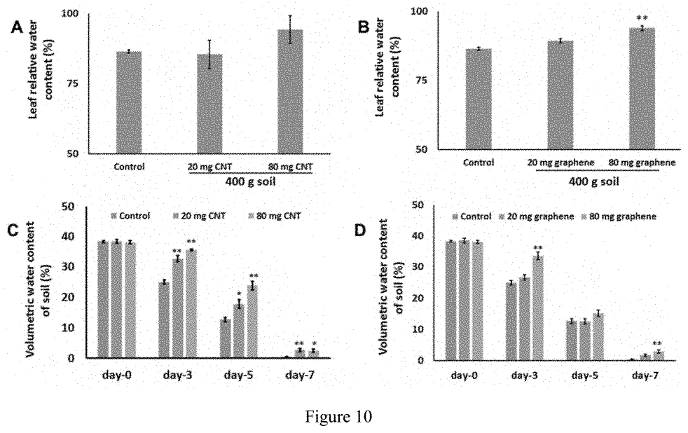

Indeed, exposure of mature Catharanthus to graphene or CNT results in higher leaf relative water content as compared to leaves of untreated (control) Catharanthus plants. FIG. 10 shows the effects of CBNs on leaf relative water content of Catharanthus cultivated at CNTs mixed soil (FIG. 10A) and graphene mixed soil (FIG. 10B) in conditions of more ware deficit stress. Moisture content of Catharanthus cultivated soil mixed with CNTs (FIG. 10C) and graphene (FIG. 10D) was measured. The final concentration of CNT and graphene was 20 mg or 800 mg per 400 g of soil mix. Delivery of CNT to soil mix was achieved by the addition of CNT of graphene solution to the soil for 4 weeks. (*=p<0.05 and **p<0.01) As shown by the results in FIG. 10, the introduction of nanomaterials (80 mg CBNs per 400 g of soil) significantly increased the Catharanthus leaf relative water content. Moreover, measurement of the volumetric water content of pot soil used for plant cultivation revealed that the CBNs treated soil contained more moisture than the untreated soil at day-3, day-5, and day-7 of imposed drought stress (FIG. 10 C, D). This observation clearly indicates that when CBNs is mixed to the soil, the soil moisture content will be maintained for longer period of time.

It should be noted that, though the sodium choloride NaCl has been used as the salt inducing salinity stress in the experiments of present invention, it does not prevent the present invention being applicable to salinity stress caused by other salts, such as potassium salts, magnesium salts, calcium salts, aluminum salts, sulfate salts, phosphate salts, and etc.

It should also be noted that, though the MS medium and soil have been used as the growth mediums for cultivating seed plants in the experiments of the present invention, others commonly used growth mediums in either liquid phase or solid phase can also be used as the growth mediums for the seed plants cultivation and the application of CBN. The liquid phase growth mediums may comprise one or a combination of agar, hydroponics, and other commonly used liquid mediums for cultivating plants. The solid phase growth mediums may comprise one or a combination of soil, soil mix, sands, clays, loams, silts and other commonly used solid mediums for cultivating plants, either natural or artificial.

The foregoing description of the exemplary embodiments of the invention has been presented only for the purposes of illustration and description and is not intended to be exhaustive or to limit the invention to the precise forms disclosed. Many modifications and variations are possible in light of the above teaching.

The embodiments were chosen and described in order to explain the principles of the invention and their practical application so as to enable others skilled in the art to utilize the invention and various embodiments and with various modifications as are suited to the particular use contemplated. Alternative embodiments will become apparent to those skilled in the art to which the invention pertains without departing from its spirit and scope. Accordingly, the scope of the invention is defined by the appended claims rather than the foregoing description and the exemplary embodiments described therein.

Some references, which may include patents, patent applications and various publications, are cited and discussed in the description of this disclosure. The citation and/or discussion of such references is provided merely to clarify the description of the present disclosure and is not an admission that any such reference is “prior art” to the disclosure described herein. All references cited and discussed in this specification are incorporated herein by reference in their entireties and to the same extent as if each reference was individually incorporated by reference.

What is claimed is:

1. A method for reducing salinity stress symptoms in a seed plant, comprising:
adding carbon-based nanomaterials into a salinity growth medium in which the seed plant is cultivated;
wherein the salinity growth medium is in a salinity condition which causes the seed plant cultivated in the growth medium demonstrates the salinity stress symptom.

2. The method for reducing salinity stress symptoms in a seed plant according to claim 1, wherein:
carbon-based nanomaterials comprises at least one of carbon nanotubes (CNT) and graphene.

3. The method for reducing salinity stress symptoms in a seed plant according to claim 1, wherein:
the salinity stress symptom comprises at least one of lower germination rate, shorter shoot length, and shorter root length, as compared to the seed plant cultivated in a non-salinity growth medium.

4. The method for reducing salinity stress symptoms in a seed plant according to claim 1, wherein:
the salinity stress symptom comprises at least one of less leaf production, less flower production, and less fruit production, as compared to the seed plant cultivated in a non-salinity growth medium.

5. The method for reducing salinity stress symptoms in a seed plant according to claim 2, wherein:
the concentration of CNT ranges between 50-1000 μg/ml;
the concentration of graphene ranges between 50-1000 μg/ml.

6. The method for reducing salinity stress symptoms in a seed plant according to claim 3, wherein:
the seed plant is one of switchgrass, sorghum, cotton, and Catharanthus roseus.

7. The method for reducing salinity stress symptoms in a seed plant according to claim 4, wherein:
the seed plant is one of cotton and Catharanthus roseus.

8. The method for reducing salinity stress symptoms in a seed plant according to claim 1, wherein:
the salinity growth medium is in a liquid phase or a solid phase.

9. The method for reducing salinity stress symptoms in a seed plant according to claim 1, wherein:
the carbon-based nanomaterials increase the expression of genes encoding aquaporins.

10. The method for reducing salinity stress symptoms in a seed plant according to claim 9, wherein:
the gene encodes PIP1;5.

11. A method for relieving drought symptoms demonstrated by a seed plant cultivated in a growth medium, comprising:
adding carbon-based nanomaterials into the growth medium in which the seed plant is cultivated for a treatment period before a water deprivation period.

12. The method for relieving drought symptoms demonstrated by a seed plant cultivated in a growth medium according to claim 11, wherein:
carbon-based nanomaterials comprises at least one of carbon nanotubes (CNT) and graphene.

13. The method for relieving drought symptoms demonstrated by a seed plant cultivated in a growth medium according to claim 12, wherein:
the concentration of CNT ranges between 20-800 mg per 400 g growth medium;
the concentration of graphene ranges between 20-800 mg per 400 g growth medium.

14. The method for relieving drought symptoms demonstrated by a seed plant cultivated in a growth medium according to claim 11, wherein:
the seed plant is one of cotton and Catharanthus roseus.

15. The method for relieving drought symptoms demonstrated by a seed plant cultivated in a growth medium according to claim 11, wherein:
after the water deprivation period, leaf relative water content of the seed plant cultivated in the growth medium supplemented by the carbon-based nanomaterials is higher than the leaf relative water content of the seed plant cultivated in a growth medium not supplemented by the carbon-based nanomaterials.

16. The method for relieving drought symptoms demonstrated by a seed plant cultivated in a growth medium according to claim 11, wherein:
the treatment period is at least two weeks.

17. A method for increasing the yield production of a seed plant, comprising:
adding carbon-based nanomaterials into a growth medium in which the seed plant is cultivated.

18. The method for increasing the yield production of a seed plant according to claim 17, wherein:
the carbon-based nanomaterials comprises at least one of carbon nanotubes (CNT) and graphene.

19. The method for increasing the yield production of a seed plant according to claim 18, wherein:
the concentration of CNT ranges between 50-1000 μg/ml;
the concentration of graphene ranges between 50-1000 μg/ml.

20. The method for increasing the yield production of a seed plant according to claim 17, wherein:
the seed plant is cotton.

21. The method for increasing the yield production of a seed plant according to claim 17, wherein:
the yield production is fiber weight produced by the cotton;
the fiber weight produced by the cotton cultivated in the growth medium supplemented by the carbon-based nanomaterials is more than the fiber weight produced by the cotton cultivated in the growth medium that is not supplemented by the carbon-based nanomaterials.
